(19) United States
(12) Patent Application Publication
(10) Pub. No.: US 2010/0255605 A1
(43) Pub. Date: Oct. 7, 2010

(54) METHOD AND DEVICE FOR TRANSFERRING BIOLOGIC FLUID SAMPLES

(75) Inventor: Stephen C. Wardlaw, Lyme, CT (US)

Correspondence Address: O''Shea Getz P.C., 1500 MAIN ST. SUITE 912, SPRINGFIELD, MA, 01115, US

(73) Assignee: Abbott Point of Care, Inc., Princeton, NJ (US)

(21) Appl. No.: 12/417,399

(22) Filed: Apr. 2, 2009

(51) Int. Cl. G01N 1/10; B01L 3/02

(52) U.S. Cl. 436/180; 422/100

(57) ABSTRACT

A biologic fluid sample transfer device and method is provided. The device includes an outer casing and a lance. The outer casing has a tip with an exterior surface and a bore extending lengthwise through the tip and out to the exterior surface of the tip to form an aperture in the exterior surface. The lance has a length extending between an operating end and a sample end. The lance includes a seal segment contiguous with the sample end. The seal segment extends a distance lengthwise and has a constant cross-sectional geometry. The transfer device is selectively disposable in an empty volume position and a sample volume position by relative lengthwise movement between the outer casing and the lance. In the empty volume position, the sample end extends outside of the aperture. In the sample volume position, the sample end of the lance is disposed within the bore a distance away from the aperture. The seal segment of the lance forms an interference fit with the bore, which interference fit is operable to create a seal between the seal segment and the bore.

### BACKGROUND OF THE INVENTION

1. Technical Field

The present invention relates to apparatus and methods for biological sample containers in general, and to biological sample containers operable to transfer precise amounts of sample in particular.

2. Background Information

Closed-tube blood sampling systems are an integral part of most modern clinical laboratory blood analyzers because avoiding having to open an evacuated blood collection tube (e.g., the Vacutainer® sample collection device marketed by Becton, Dickinson and Company, New Jersey, U.S.A.) reduces the chance of aerosolized blood droplets and the subsequent risk of contamination or infection. In general, these systems operate by pushing a hollow trochar through the stopper (or other closure) of such a blood collection tube and then inserting a hollow probe through the bore of the trochar to extract some of the sample for analysis. Alternately, a single or multi-bore needle is inserted through the stopper and sample is directly withdrawn in amounts varying from about 50 microliters to 200 microliters, in the case of instruments for measuring complete blood counts (CBCs). Because both the inside and outside of the sampling apparatus is contaminated, after each sample, the trochar and sampling tube must be washed to avoid cross-contamination, which adds substantial complexity and cost to the sampling mechanism. An additional disadvantage of such a sampling arrangement is that the sample tube must hold some minimum quantity of material so that the probe can reach the sample.

In an analytical system which requires a much smaller quantity of blood than existing systems (e.g., those described in U.S. Patent Publication No. 2007/0243117 and U.S. Pat. No. 6,866,823), another more effective means can be used to extract samples from closed sample tubes and transfer the sample to the analytical system. One that overcomes the disadvantages of carry-over and large minimum sample requirement would be of great benefit.

### SUMMARY OF THE INVENTION

According to an aspect of the present invention, a biologic fluid sample transfer device is provided. The device includes an outer casing and a lance. The outer casing has a tip with an exterior surface and a bore extending lengthwise through the tip and out to the exterior surface of the tip to form an aperture in the exterior surface. The lance has a length extending between an operating end and a sample end. The lance includes a seal segment contiguous with the sample end. The seal segment extends a distance lengthwise and has a constant cross-sectional geometry. The transfer device is selectively disposable in an empty volume position and a sample volume position by relative lengthwise movement between the outer casing and the lance. In the empty volume position, the sample end extends outside of the aperture. In the sample volume position, the sample end of the lance is disposed within the bore a distance away from the aperture. The seal segment of the lance forms an interference fit with the bore, which interference fit is operable to create a seal between the seal segment and the bore.

According to another aspect of the present invention, a biologic fluid sample analysis system is provided. The system includes a biologic fluid sample container, a transfer device, and a biologic fluid analysis container. The biologic fluid sample container has chamber and an elastomeric seal. The transfer device has an outer casing and a lance. The outer casing has a tip with an exterior surface and a bore extending lengthwise through the tip and out to the exterior surface of the tip to form an aperture in the exterior surface. The lance has a length extending between an operating end and a sample end. The lance includes a seal segment contiguous with the sample end, which seal segment extends a distance lengthwise and has a constant cross-sectional geometry. The seal segment is received within the bore. The transfer device is selectively disposable in an empty volume position and a sample volume position by relative lengthwise movement between the outer casing and the lance. In the empty volume position the sample end extends outside of the aperture. In the sample volume position, the sample end of the lance is disposed within the bore a distance away from the aperture. The seal segment of the lance forms an interference fit with the bore, which interference fit is operable to create a seal between the seal segment and the bore. The biologic fluid sample analysis container has a port sized to receive sample from the tip of the transfer device and a chamber to receive the sample from the port.

According to another aspect of the present invention, a method of transferring biologic fluids is provided. The method includes the steps of: a) providing a biologic fluid sample within a sealed container having a piercable seal; b) providing a transfer device having an outer casing and a lance, wherein the outer casing has a tip with an exterior surface and a bore extending lengthwise through the tip out to the exterior surface of the tip to form an aperture in the exterior surface, and the lance has a length extending between a operating end and a sample end, the lance including a seal segment contiguous with the sample end, which seal segment extends a distance lengthwise and has a constant cross-sectional geometry, wherein the transfer device is selectively disposable in an empty volume position and a sample volume position by relative lengthwise movement between the outer casing and the lance, and wherein in the empty volume position the sample end extends outside of the aperture, and in the sample volume position the sample end of the lance is disposed within the bore a distance away from the aperture, and wherein the seal segment of the lance forms an interference fit with the bore, which interference fit is operable to create a seal between the seal segment and the bore; c) disposing the transfer device in the empty volume position and inserting the tip through the piercable seal and into contact with the biologic sample; d) moving one or both of the lance and the outer casing relative to the other to a sample volume position, thereby drawing sample into the bore; e) withdrawing the tip from the container; and f) moving one or both of the lance and the outer casing relative to the other to the empty volume position, thereby discharging the sample from the bore.

The present method and advantages associated therewith will become more readily apparent in view of the detailed description provided below, including the accompanying drawings.

### BRIEF DESCRIPTION OF THE DRAWINGS

FIG. 1 is a diagrammatic sectional view of an embodiment of the present transfer device with the lance and outer casing disposed in an empty volume position.

FIG. 2 is a diagrammatic sectional view of an embodiment of the present transfer device with the lance and outer casing disposed in a sample volume position.

FIG. 3 is an enlarged view of a portion of the transfer device embodiment shown in FIG. 2.

FIG. 4 is a diagrammatic sectional view of an embodiment of the present transfer device in an empty volume position, with the tip of device inserted into a seal of a sample chamber.

FIG. 5 is a diagrammatic sectional view of an embodiment of the present transfer device in an empty volume position, with the tip of device inserted into a seal of a sample chamber.

FIG. 6 is a diagrammatic view of a biologic fluid analysis chamber.

### DETAILED DESCRIPTION OF EMBODIMENTS OF THE INVENTION

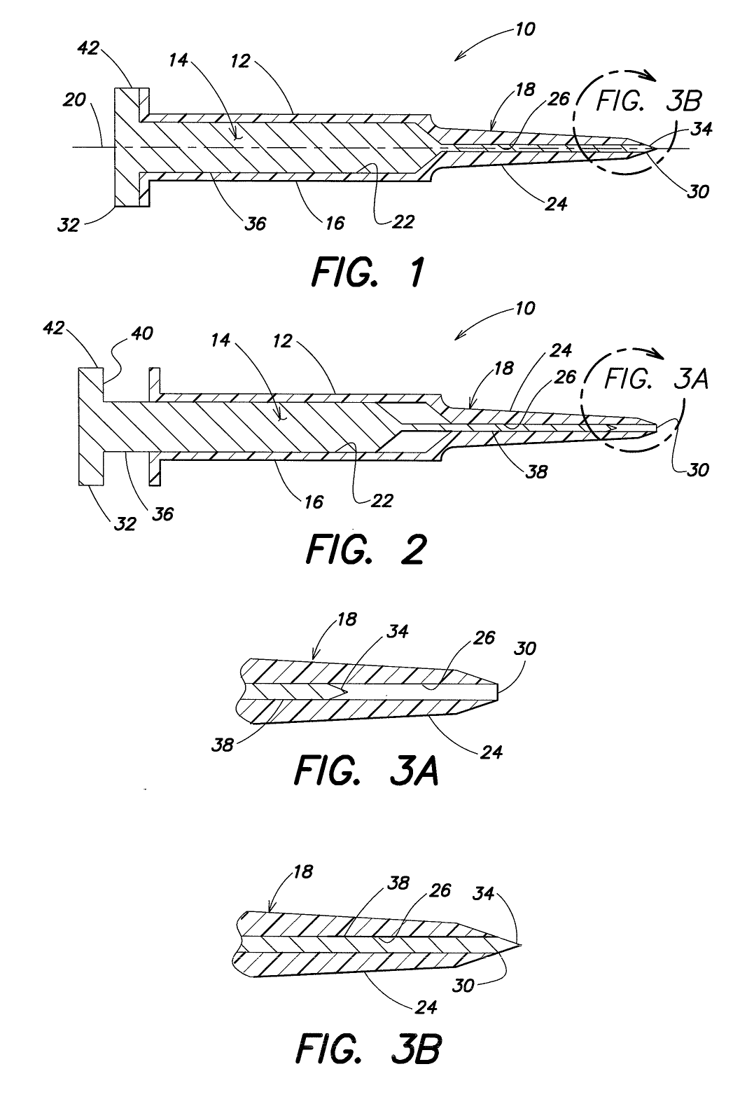

Now referring to FIGS. 1 and 2, according to an aspect of the present invention, a biologic fluid sample transfer device 10 is provided. The device 10 includes an outer casing 12 and a lance 14.

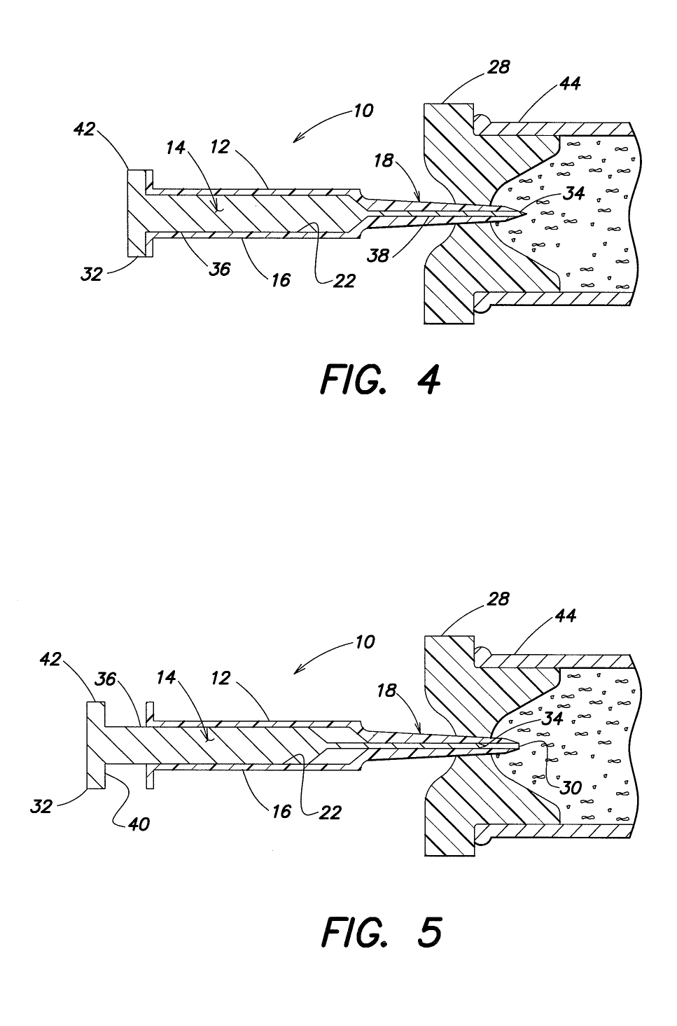

The outer casing 12 includes a barrel 16 and a tip 18 attached to one another (e.g., formed as a unitary body) disposed along a lengthwise extending central axis 20. The barrel 16 has an interior cavity 22 that has a constant cross-sectional geometry along its length. The cavity 22 cross-sectional geometry shown in FIGS. 1-5 is circular. In alternative embodiments, the barrel 16 may have a different (e.g., non-circular) cross-sectional geometry. The tip 18 has an exterior surface 24 and a centrally located bore 26 that extends lengthwise through the tip 18. The tip exterior surface 24 shown in FIGS. 1-5 is tapered to facilitate insertion of the tip 18 into a stopper 28 (or other closure). The tip 18 is not limited to a tapered exterior geometry, however. The bore 26 has a cross-sectional geometry that is constant along its length; e.g., cylindrical. The bore 26 extends through to the exterior surface 24 of the tip 18, where it forms an aperture 30 in the exterior surface 24. The aperture 30 is the same cross-sectional geometry and size (e.g., same diameter) as the bore 26. In some embodiments, the bore 26 and the cavity 22 may have the same cross-sectional geometry. In those embodiments where the bore 26 and the cavity 22 have a cylindrical geometry, the diameter of each may be the same as each other or different from each other.

The lance 14 has a length extending between an operating end 32 and a sample end 34. The sample end 34 is disposed at the opposite end of the lance 14 as the operating end 32. In FIGS. 1-5, a handle 42 is attached to the operating end 32 to facilitate relative movement between the lance 14 and the outer casing 12. In the embodiment shown in FIGS. 1-5, the sample end 34 of the lance 14 is formed in a point to facilitate insertion of the lance 14 and outer casing tip 18 into a stopper 28 as will be described below.

The lance 14 includes a guidance segment 36 and a seal segment 38. The seal segment 38 has a geometry that mates with the bore 26 of the tip 18 (e.g., both cylindrical) to form a slight interference fit between the seal segment 38 and the tip bore 26. It may also be described that the geometry of the bore 26 mates with the seal segment 38. The interference fit is such that relative movement of the lance 14 and tip 18 is permitted, yet tight enough to form a seal between the surface of the seal segment 38 and the surface of the tip bore 26. The seal is continuous around the entire perimeter of the seal segment (i.e., circumference of a cylindrical seal segment) and sufficient to prevent the passage of fluid between the seal segment 38 and the bore 26, and most preferably sufficient to force fluid out of the bore 26 without any residual fluid being disposed between the seal segment 38 and the bore 26. More specifically stated, the seal between the seal segment 38 and the bore 26 is such that when the transfer device 10 is moved from a sample volume position having sample disposed in the bore 26, to an empty volume position, any amount of sample residing in the bore 26 (if any) is of a quantity that is too small to contaminate the transfer device 10 for most analytical applications. When used with whole blood, we have determined that the present transfer device allows sampling with a carry-over of as little as 50 parts per million, without the need for any intervening washing steps. The seal between the seal segment 38 and the bore 26 is operational in the empty volume position and any sample volume positions, and all relative positions of the lance 14 and outer casing 12 therebetween.

The guidance segment 36 as shown in FIGS. 1-5 is a solid body disposed within the interior cavity 22 of the barrel 16 of the outer casing 12. In this embodiment, the cross-sectional area of the guidance segment 36 mates with the interior cavity 22 to form a slide fit which is sufficiently tight to provide adequate translational guidance for relative movement between the lance 14 and the outer casing 12, but loose enough to not impede such movement. It may also be described that the interior cavity 22 mates with the guidance segment 36. In alternative embodiments, the guidance segment 36 can be other than a solid body (e.g., a hollow body) and may include a geometric configuration (e.g., an “×” or a “+”) with guidance surfaces at the interface(s) between the interior cavity 22 and the guidance segment 36.

In some embodiments, one or both of the lance 14 and the outer casing 12 (or some combination thereof) may include a physical stop 40 or detent means that define relative positions between the lance 14 and the outer casing 12. For example, the transfer device 10 shown in FIGS. 1-5 includes a handle 42 positioned to act as a positive stop associated with an empty volume position as will be further described below.

The lance 14 and the outer casing 12 may comprise any material that permits the above-described seal between the bore 26 and the seal segment 38. For example, the outer casing 12 may be formed from a material that is elastic relative to the material comprising the lance 14, or vice versa. The relative elasticity between the materials facilitates the slight interference fit between the seal segment 38 and the bore 26 of the tip 18 that creates the desired seal. To give a specific example, the outer casing 12 may be formed from an elastomeric material (e.g., polypropylene) and the lance 14 formed from a metallic material (e.g., stainless steel). These materials are an example and the present invention is not limited thereto.

The outer casing 12 and the lance 14 are moveable relative to each other in a lengthwise direction. When the lance 14 is positioned within the outer casing 12 such that the sample end 34 extends outside of the tip aperture 30, the transfer device 10 is in a position referred to as an “empty volume position”. In this position, a portion of the seal segment 38 is disposed within the aperture 30. The transfer device 10 shown in FIGS. 1, 3B, and 4 is depicted in the “empty volume position”. In this position, at least the portion of the bore 26 contiguous with the aperture 30 is filled with the seal segment 38 of the lance 14 and the sample end 34 of the lance 14 extends past the aperture 30, and outside of the tip 18. As a result, there is no volume of the bore 26 that can be filled with biologic fluid sample. The seal between the seal segment 38 and the bore 26 prevents migration of the sample into the transfer device 10 under normal operating conditions.

The lance 14 and outer casing 12 can be moved relative to one another to put the transfer device 10 in a “sample volume position”. In a sample volume position, the lance 14 is moved lengthwise until the sample end 34 is drawn some distance into the bore 26 of the tip 18. The distance that the sample end 34 is drawn into the bore 26 will dictate the volume of the fluid sample drawn into the transfer device 10; e.g., the diameter of the bore 26 times the length of the exposed bore 26, taking into consideration the geometry of the sample end 34 of the lance 14. The transfer device 10 shown in FIGS. 2, 3A, and 5 is depicted in the “sample volume position”. As indicated above, the seal between the seal segment 38 and the bore 26 prevents migration of the sample into the transfer device 10 under normal operating conditions. The transfer device 10 is not limited to a single sample volume position and may assume a plurality of such positions, each associated with a different volume of sample disposed within the bore 26. As indicated above, the transfer device 10 may include one or more physical stops or detent means that identify the particular sample volume positions.

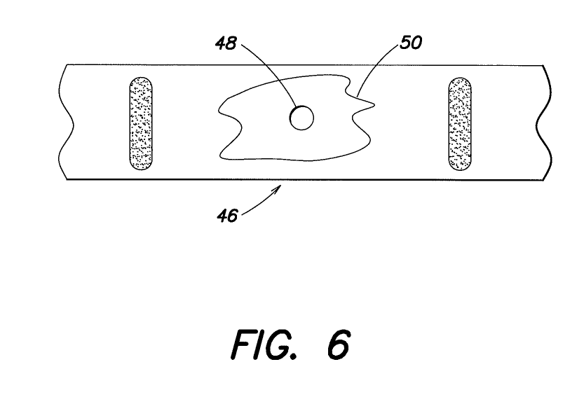

Now referring to FIG. 6, in performing an analysis on a biologic fluid sample, the sample is typically disposed within an analysis chamber 46 having particular characteristics (geometry, reagents, etc.) that are useful in the analysis. Examples of analysis chambers include those described in U.S. Patent Application Publication Nos. 2007/0243117, 2007/0087442, and U.S. patent application Ser. No. 6,723,290, all of which are hereby incorporated by reference in their entirety. The analysis of the sample can be performed using a analytical device such as that described in U.S. Pat. No. 6,866,823 entitled “Apparatus for Analyzing Biologic Fluids” and issued Mar. 15, 2005, which is also hereby incorporated by reference in its entirety.

Not all biologic fluid samples are collected and deposited directly in an analysis chamber 46, however. Fluid samples (e.g., whole blood samples) are often harvested from a subject and deposited in a sealed container 44. A Vacutainer® type biologic sample container (available from Becton, Dickinson and Company, New Jersey, U.S.A.) is an example of a container 44 that can be used to collect a sample from a subject.

The present transfer device provides a desirable tool for transferring sample from such a container 44 and depositing it in an analysis chamber 46 as described above. The present transfer device 10 also provides a means for the transfer of a precise amount of sample with minimal potential of contamination of that sample, or contamination of the transfer device 10 after the transfer procedure. The present invention is not limited to use with any particular container 44. The following is an example of the present transfer device 10 used in concert with a container such as a Vacutainer® to illustrate the utility of the present invention.

The sample container 44 has a stopper 28 or other closure, sealing across an orifice. In the case of the Vacutainer®, the seal is an elastomeric stopper 28 that seals the orifice of a tubular container. The transfer device 10 is positioned in an empty volume position. If the container is not filled with sample, the container is oriented to place sample in contact with the stopper 28, an operation which is not readily accomplished with prior art sampling systems. The tip 18 of the transfer device 10 is inserted through the stopper 28, thereby disposing at least the sample end 34 of the lance 14 in contact with the fluid sample, and likely a portion of the outer casing tip 18. The position of the sample end 34 extending out from the tip 18 facilitates the insertion. The protrusion of the sample end 34 and the seal between the seal segment 38 and the bore 26 prevent any migration of the fluid sample into the bore 26. It should be realized that the act of piercing may be a function of the outer sheath, the inner lance, or the combination of the two. Because of the small outer diameter of the assembly, it is preferable, to maximize the strength of the device by having the lance fully engaged with the sample end 34 at least flush with or extending slightly out from the aperture 38 of the outer casing 12 so that the elements mutually support each other. This also prevents distortion of the outer tip 18 due to the force of piercing the stopper 28.

The lance 14 is subsequently withdrawn a distance into the bore 26 thereby placing the transfer device 10 in a sample volume position. In this position, a particular volume of sample is drawn into the bore 26, which volume is known or determinable. The transfer device 10 is withdrawn from the container. As the tip 18 is withdrawn, the elastomeric stopper 28 wipes any residual sample from the exterior surface 24 of the tip 18. The sample is maintained within the bore 26 by capillary forces.

The transfer device 10 may subsequently be engaged with an analysis chamber 46 (see FIG. 6) as is described above, typically with a port 48 designed to accept biologic fluid sample, and preferably one sized to mate with the tip 18 of the transfer device 10. The lance 14 and outer casing 12 are subsequently moved relative to one another to discharge the fluid sample 50 from the bore 26. All or some of the sample may be discharged. In those applications where the lance 14 is disposed in a particular sample volume position relative to the bore 26, which position is associated with a particular volume of sample, a precise amount of sample can be discharged by moving the lance 14 from the sample volume position to the empty volume position. In embodiments having a plurality of sample volume positions, multiple sample volumes can be discharged.

As the lance 14 is moved relative to the bore 26 to discharge sample, the seal between the seal segment 38 and the bore 26 prevents fluid leakage there between. As a result, the amount of sample that is discharged from the transfer device 10 can be accurately determined, and the transfer device 10 is purged of sample, thereby permitting multiple uses of the transfer device 10 without contamination of sample. When used with whole blood, we have determined that the present transfer device allows sampling with a carry-over of as little as 50 parts per million, without the need for any intervening washing steps.

Although this invention has been shown and described with respect to the detailed embodiments thereof, it will be understood by those skilled in the art that various changes in form and detail may be made without departing from the spirit and scope of the invention.

1. A biologic fluid sample transfer device, comprising:
an outer casing having a tip with an exterior surface and a bore extending lengthwise through the tip and out to the exterior surface of the tip to form an aperture in the exterior surface; and
a lance having a length extending between an operating end and a sample end, the lance including a seal segment contiguous with the sample end, which seal segment extends a distance lengthwise and has a constant cross-sectional geometry, and which seal segment is received within the bore;
wherein the transfer device is selectively disposable in an empty volume position and a sample volume position by relative lengthwise movement between the outer casing and the lance;
wherein in the empty volume position the sample end extends at least flush with the exterior surface, and in the sample volume position the sample end of the lance is disposed within the bore a distance away from the aperture; and
wherein the seal segment of the lance forms an interference fit with the bore, which interference fit is operable to create a seal between the seal segment and the bore.

2. The transfer device of claim 1, wherein the tip and the sample end of the lance are configured so as to be insertable within an elastomeric closure of a biologic sample tube.

3. The transfer device of claim 2, wherein the sample end is pointed.

4. The transfer device of claim 1, wherein the bore and the seal segment have mating geometries.

5. The transfer device of claim 4, wherein the seal between the seal segment and the bore is continuous around the entire perimeter of the seal segment.

6. The transfer device of claim 5, wherein the seal between the seal segment and the bore is such that when the transfer device is moved from a sample volume position having sample disposed in the bore to an empty volume position, substantially all of the sample is discharged from the bore.

7. The transfer device of claim 5, wherein the seal between the seal segment and the bore is intact in the empty volume position and one or more sample volume positions and relative positions of the lance and outer casing therebetween.

8. The transfer device of claim 4, wherein the bore and the seal segment are cylindrical.

9. The transfer device of claim 8, wherein the aperture and the bore are the same diameter.

10. The transfer device of claim 9, wherein a portion of the seal segment is disposed in the aperture in the empty volume position.

11. The transfer device of claim 1, wherein the lance further includes a guidance segment, and the outer casing includes a barrel having an interior cavity, wherein the guidance segment is receivable within the interior cavity of the barrel.

12. The transfer device of claim 11, wherein the guidance segment fauns a slide fit with the barrel.

13. The transfer device of claim 12, wherein the guidance segment is cylindrical.

14. The transfer device of claim 13, wherein the bore and the seal segment have mating geometries.

15. The transfer device of claim 14, wherein the bore and the seal segment are cylindrical.

16. The transfer device of claim 15, wherein the seal segment and the guidance segments have different diameters.

17. A biologic fluid sample analysis system, comprising:
a biologic fluid sample container having an elastomeric seal;
a transfer device having an outer casing and a lance, wherein the outer casing has a tip with an exterior surface and a bore extending lengthwise through the tip and out to the exterior surface of the tip to form an aperture in the exterior surface, and the lance has a length extending between an operating end and a sample end, the lance including a seal segment contiguous with the sample end, which seal segment extends a distance lengthwise and has a constant cross-sectional geometry, and which seal segment is received within the bore, wherein the transfer device is selectively disposable in an empty volume position and a sample volume position by relative lengthwise movement between the outer casing and the lance, and wherein in the empty volume position the sample end extends at least flush with the exterior surface, and in the sample volume position the sample end of the lance is disposed within the bore a distance away from the aperture, and wherein the seal segment of the lance forms an interference fit with the bore, which interference fit is operable to create a seal between the seal segment and the bore; and
a biologic fluid sample analysis chamber having a port sized to receive sample from the tip of the transfer device.

18. A method of transferring biologic fluids, comprising the steps of:
providing a biologic fluid sample within a sealed container having a piercable seal;
providing a transfer device having an outer casing and a lance, wherein the outer casing has a tip with an exterior surface and a bore extending lengthwise through the tip and out to the exterior surface of the tip to form an aperture in the exterior surface, and the lance has a length extending between a operating end and a sample end, the lance including a seal segment contiguous with the sample end, which seal segment extends a distance lengthwise and has a constant cross-sectional geometry, wherein the transfer device is selectively disposable in an empty volume position and a sample volume position by relative lengthwise movement between the outer casing and the lance, and wherein in the empty volume position the sample end and a portion of the seal segment extends at least flush with the exterior surface, and in the sample volume position the sample end of the lance is disposed within the bore a distance away from the aperture, and wherein the seal segment of the lance forms an interference fit with the bore, which interference fit is operable to create a seal between the seal segment and the bore;
disposing the transfer device in the empty volume position and inserting the tip through the piercable seal and into contact with the biologic sample;
moving one or both of the lance and the outer casing relative to the other to a sample volume position, thereby drawing sample into the bore;
withdrawing the tip from the container; and
moving one or both of the lance and the outer casing relative to the other to the empty volume position, thereby discharging the sample from the bore.

19. The transfer device of claim 1, wherein the seal segment of the lance is configured within the bore of the outer casing such that when the transfer device is moved from the empty volume position to the sample volume position, the lance is operable to draw a sample into the bore of the outer casing.
